(19) United States
(12) Patent Application Publication
(10) Pub. No.: US 2010/0106716 A1
(43) Pub. Date: Apr. 29, 2010

(54) Determining method of indication order of search results, system, program, recording medium

(76) Inventor: Teru Matsuda, Takatsuki (JP)

Correspondence Address: Teru Matsuda, 1-15-13 Octenjin-cho, Takatsuki-shi, 532-1118, JP

(21) Appl. No.: 12/546,707

(22) Filed: Aug. 25, 2009

(30) Foreign Application Priority Data
Oct. 28, 2008 (JP) 2008-301685
Nov. 18, 2008 (JP) 2008-317677

(51) Int. Cl. G06F 7/08; G06F 17/30; G06N 5/02

(52) U.S. Cl. 707/723; 706/47; 707/E17.014

(57) ABSTRACT

When user requests internet search with some keywords, score is calculated for each site to which keyword is hit according to a predetermined algorithm and each site is indicated according to the calculated score. At a predetermined timing the indicated order is shuffled irrespective of the score. The timing is at request of search or a certain period. The range of indication order to be shuffled is fixed number, ratio, variable, and so on.

### BACKGROUND OF THE INVENTION

1. Field of the Invention

The present invention relates to a method to indicate search results used in internet technology and so on.

2. Related Art of the Invention

In the prior art for example, the following method have been almost used for search method in the internet technology. Firstly evaluation value for each web site is counted by using a predetermined calculation rule which is made by service provider. For example evaluation value for each web site is calculated by using such elements of the number of the cover links of each site, evaluation valued of the cover links, quality of the site, frequency of update, design, access number or etc.

Secondly when a user requests the search with a certain keyword, distance values are calculated between the keyword and each site. And score of each site is calculated with the predetermined algorithm by using the evaluation value of each site and the distance value of each site. And a plurality of sites are determined as the candidates to be indicated, by using the score.

Next order of indication for the candidates of the plurality of sites is determined according to the score in high order.

On the display of computer of the user, index of each site is indicated according to such determined indication order, usually sequentially from the top, as the search results.

However according to such conventional indication method of search results, even though the service provider does large efforts to make precise, minute score calculation rule, preference or subjectivity of the service provider is always included in the rule. For example the design has subjectivity and the number of the cover links can be increased by special manner of SEO provider and further it can not be said that the much the number of the cover links is, the better the site is. Further it can not be said that when the cover link is official, the site is good. Further it can not be said that when the number of the cover links is many, the site is good.

Further in the present world the number of the web site increases exponentially and therefore it is extremely doubt that such few number of indicated sites on the first page of the display have precise, important and search hit rate.

Then natural language search method has been developed in stead of using keywords. Or interactive question method was developed. But the former method is immature yet and the latter is troublesome.

In the first place the desires of the users are different. One desire is for knowledge, another is for convenient item. One desire is for comparison of prices, another is for analysis of physics.

Therefore there is essentially unreasonableness in the conventional determining method of the indication order of the search results.

Then the present invention intends to offer such fair indication method of the search results that there is no deflection.

### SUMMARY OF THE INVENTION

The first aspect of the present invention is a determining method of indication order of search results, wherein

when first indication order of site information for each searched and hit site is decided according to a predetermined rule, and second indication order of the site information for the each searched and hit site is decided on the basis of the first indication order of site information,

The second indication order is decided by shuffling indication order which is to be shuffled, at a predetermined timing and within a determined indication order range.

The second aspect of the present invention is the determining method according to the first aspect, wherein

scores which was finally added to the searched and hit sites, said scores being used for deciding the first indication order, are calculated by using evaluation value which is prepared beforehand for each site and distance between search keyword or key-sentence and contents of each site.

For example the evaluation value is calculated from evaluation value references of quality, design, update frequency, number of cover links, quality of cover links, number of cover access and is weighted. The calculation is executed beforehand for web sites as many as can and results are recorded with entity information of these sites.

The third aspect of the present invention is the determining method according to the first aspect, wherein

the indication order which is to be shuffled, is the first indication order.

For example when shuffle is executed, the indication order which is to be shuffled is such indication order corresponding to score value.

The fourth aspect of the present invention is the determining method according to the first aspect, wherein

the indication order which is to be shuffled, is such indication order which is result of the last time shuffle or which is result of the former shuffle.

The fifth aspect of the present invention is the determining method according to the first aspect, wherein

the predetermined indication order range is decided by number of sites.

For example the number is every 5.

The sixth aspect of the present invention is the determining method according to the fifth aspect, wherein

the number of sites is counted from high rank or low rank.

For example the range is decided by counting by ten from the top against the indication order corresponding to the score value.

The seventh aspect of the present invention is the determining method according to the fifth aspect, wherein

the number is fixed or variable according to a certain rule.

For example at every shuffle such variation occurs as 10-15-20-10.

The eighth aspect of the present invention is the determining method according to the first aspect, wherein

the predetermined indication order range is ratio for total number of the searched and hit sites.

For example when 1000 sites are hit by searching, shuffle is done within by 10%, namely, 100 sites. And when 100 sites are hit by searching, shuffle is done within by 10%, namely, 10 sites. Or the ranges can be 1%, 5%, 10% from upper.

The ninth aspect of the present invention is the determining method according to the eighth aspect, wherein

the ratio is counted from high rank or low rank.

For example one shuffle is done within 1 to 10 sites from upper and another shuffle is done within 11 to 20 sites from upper. Or when 100 sites are hit, one shuffle is done within 1 to 10 sites from lowest and another shuffle is done within 11 to 20 sites from lowest.

The tenth aspect of the present invention is the determining method according to the eighth aspect, wherein

the ratio is fixed or variable according to a certain rule.

For example 10% is fixed. Or 10% is for first and second shuffles and it is changed to 20% from third shuffle operation.

The 11th aspect of the present invention is the determining method according to the first aspect, wherein

the predetermined indication order range is decided by utilizing the scores which was finally added to the searched and hit sites, said scores being used for deciding the first indication order.

The 12th aspect of the present invention is the determining method according to the second aspect, wherein

the predetermined indication order range is decided by utilizing the value of the score.

The 13th aspect of the present invention is the determining method according to the 11th aspect or 12th aspect, wherein

the predetermined indication order range is such certain indication order range where difference of the score values of the sites belonging to such range falls within a predetermined size.

For example shuffle is done for such sites that have score value difference within 3 points. This is because it is meaningless to distinguishing them having 3 points or less difference with respect to the indication order. On the contrary among such sites having 4 points or more shuffle is not done.

The 14th aspect of the present invention is the determining method according to the 13th aspect, wherein

the predetermined size is counted from high rank or low rank.

For example when the most upper site has 100 points, the 3 points difference is counted from 100 points and then such range having 100 to 97 points is shuffled.

The 15th aspect of the present invention is the determining method according to the 13th aspect, wherein

the predetermined size is fixed to a predetermined value width or is variable according to a certain rule.

For example the 3 points is fixed or 3 is changed to 5 from third shuffle.

The 16th aspect of the present invention is the d Determining method according to the 13th aspect, wherein

the predetermined size is decided on the basis of calculated score values.

For example against such sites group having lower score value, the size becomes smaller because it is better that shuffle is hard to come to occur for such group.

The 17th aspect of the present invention is the determining method according to the 11th or 12th aspect, wherein

the predetermined indication order range is decided by a predetermined value width of the score.

For example when 1000 point is upper limit, 1000 points are divided by 5 points from upper limit, and shuffle is done every each block of 5 points.

The 18th aspect of the present invention is the determining method according to the first aspect, wherein

the predetermined indication order range is all searched and hit sites or a part of the all searched and hit sites.

For example when the number of hit sites is 3000, shuffle is done only for the 100 sites from upper limit.

The 19th aspect of the present invention is the determining method according to the 18th aspect, wherein

the part is a certain sites of high rank.

The 20th aspect of the present invention is the determining method according to the first aspect, wherein

the predetermined timing is at per user's search request, at a certain period, at random or at shuffle request of user.

For example shuffle is done at user's request of search. Or it is done every 3 days. Or it is done at random by using random number. Or it is done when user request shuffle. Or the timing is variable according to bigness of the number of access.

For example shuffle is done at user's request of search. Or it is done every 3 days. Or it is done at random by using random number. Or it is done when user request shuffle. Or the timing is variable according to bigness of the number of access.

The 21th aspect of the present invention is the determining method according to the first aspect, wherein

old the second indication order is recorded and later the old second indication can be indicated.

For example under such shuffle operation there is such case that after the user look the indication order of site information, the user wishes to look the old indication order of site information. For such case old indication order of site information is recorded, and old indication order of site information can be reappears. Such function can be realized on the user side computer or can be on the search provider system.

The 22th aspect of the present invention is the determining method according to the first aspect, wherein

boundary of adjacent predetermined indication order ranges is variable according to a predetermined rule.

For example the range is decided by number or ration etc. further boundary of each block within which the shuffle is done, can be variable to realize smaller deflection.

The 23th aspect of the present invention is the determining system of indication order of search results, comprising;

database section recording data of many sites,

search section searching for user's search request by using the database section, and

indication order decide section, where

in the indication order decide section,

when first indication order of site information for each searched and hit site is decided according to a predetermined rule, and second indication order of the site information for the each searched and hit site is decided on the basis of the first indication order of site information,

the second indication order is decided by shuffling indication order which is to be shuffled, at a predetermined timing and within a determined indication order range.

The 24th aspect of the present invention is the program on the recording medium, realizing by the computer, the determining method of indication order of search results, wherein

when first indication order of site information for each searched and hit site is decided according to a predetermined rule, and second indication order of the site information for the each searched and hit site is decided on the basis of the first indication order of site information,

the second indication order is decided by shuffling indication order which is to be shuffled, at a predetermined timing and within a determined indication order range.

The present invention is for example such that when user requests internet search with some keywords, score is calculated for each site to which keyword is hit according to a predetermined algorithm and each site is indicated according to the calculated score. At a predetermined timing the indicated order is shuffled irrespective of the score. The timing is at request of search or a certain period. The range of indication order to be shuffled is fixed number, ratio, variable, and so on.

According to the present invention search results can be indicated fairly with no deflection.

### PREFERRED EMBODIMENTS OF THE INVENTION

FIG. 1 shows one embodiment of the present invention.

The meaning of shuffle of the present invention is not limited to perfect random exchange but sequential move back or sequential move forward or any exchange or any variation.

Database making section 6 makes a database section 1 for each site A, B, C, D, - - - by crawl. Evaluation value of each site is added to the database by predetermined algorithm calculation. For example a number of cover links, number of access, quality etc. are used for the calculation. User input keyword or key-sentence to be searched by using keyword input section 2 of user's computer.

Search section 3 searches site which is suitable for the keyword from the database section 1. Distance between the keyword and each site is calculated according to predetermined algorithm. For example when the keywords are plural and all keywords appear in sentences of the site, the calculated distance is made short. Further the search section 3 calculates score of each site on the basis of the distance and the evaluation value of the site according to predetermined rule (algorithm). In addition the score can be calculated by using other elements of each site also.

The indication order decide section 4 decides the order of indication (first indication order) according to the score of each site. Usually in the first indication order, high score site is indicated at upper position. Further the indication order decide section 4 decides as below the second indication order which is to be displayed on the display 5 of the computer of user, as the search results, on the basis of the decided first indication order. The display 5 presents entity information of site as the results of search on the display 5 according to the second indication order.

The second indication order is decided by shuffle. That is indication order decide section 4 shuffles the order of the indication of each site when other user requests search or same user requests search at different time. Or the shuffle can be done at random or three days interval. The shuffle can be done at any trigger. The shuffle is executed irrespective of the score. That is even if the score of each site are not changed, the shuffle is executed.

The manner of the shuffle is mentioned below.

### Manner of shuffle

Within certain range (area, number) of the indicated sites, shuffle is done ignoring the big or small of the score. Or with perfect random. Or with moving sites back sequentially (the last moves to the top). Or with moving sites forwards sequentially (the top moves to the last). In short, within certain range the indication order becomes not corresponding to the big or small of the score by the shuffle even though in all even though in some.

### Deciding Manner of Shuffle Range

a. As FIG. 2 the shuffle range is determined according to the score. For example such sites falls within range of 100 points to 96 points are shuffled when the 100 points is upper limit. For sites of the range of 96 points to 91 similar shuffle is done. The size of the respective range can be same (100-96 and 95-91) but can be different (100-96 and 95-89). Or the size of the range can be varied in terms of time. Or the shuffle can be done among such sites having score within 3 points difference. That is because small score difference has no significance in order to decide indication order for the user

b. As FIG. 3 the range can be determined according to fixed number (example per 5, or 10-20-30). For example per 5 from upper. Further the number can be changed in terms of time. Or it can be done that many sites which is under a predetermined score or order are not shuffled.

c. ratio can be used (ex. per 10%, or 10%-20%-30%) For example for searched hit all sites divided per 10% and within the divided block shuffle is done. Or upper block is 1%, next block is 5% and so on can be done. That is the size of % cam be changed.

d. the site range to be shuffle can be searched hit all sites or can be a part of searched hit all sites. For example when hit sites are 3000, the upper 100 sites are only shuffled but the remaining sites are not shuffled.

### Selection of the Indication Order which is to be Shuffled

In the FIG. 3 when shuffle is being done, the indication order to be shuffled is such indication order which is corresponding to the score value. That is the indication order to be shuffled at the t1-1 timing is the indication order which is corresponding to the score value and the indication order to be shuffled at the t1-2 timing is also the indication order which is corresponding to the score value.

Or as FIG. 4 when shuffle is being done, the indication order to be shuffled is such indication order which is the order of result of just before shuffle (the last time shuffle). This is not limited the order of result of just before shuffle but past shuffle can be used when shuffle is done many times.

### Changing of Boundary of Range to be Shuffled

The boundary between respective range of sites to be shuffled can be changed. The range is decided by site number or ratio but the boundary can be changed in terms of time, thereby making the deflection less.

For example as FIG. 5, the bock boundary can be changed per at t2,t3,t4. At timing t2 the boundary is changed as the figure. In the FIG. 5 one end is moved. Thus the indication order becomes fairer.

The timing of the boundary change can be related to the access number which becomes more than 100, or certain period, or with random.

### Timing of Shuffle

The timing of shuffle is per the search access from user, or per certain period (for example when access number is many the certain period can be short), or at random. Or the shuffle can be executed by user's instruction.

Now there is such case that scores of some sites becomes same. Even though for such case, the some sites should be indicated under such order according to for example, alphabet order. But such alphabet order can be considered as calculated on the basis of score by predetermined algorithm. That is “score” means such broad meaning including such score which is amended by the alphabet order that can not be considered usually as score value. In other words the site having upper rank with respect to the alphabet order is given with higher score value than the site having lower rank with respect to the alphabet order even though the calculated scores are same. In brief such alphabet order point which is used for determining the indication order can be considered as “score”. For example when as a result of calculation A site is 88, B site is 87, C site is 87, and D site is 86, the indication order is A>B>C>D from upper considering the alphabet order between B and C. Under such case it can be that the B site has bigger score than C site.

Then that scores which was finally added to the searched and hit sites, is used for deciding the first indication order, means that the first indication order is decided according to the predetermined rule of the present invention.

Shuffle means such case that at least a part of the decided indication order is shuffled, that is a part of score is reflected to the indication order but another part of score is not reflected to the indication order.

Further, the program according to the present invention may be a program which operates in co-operation with a computer and makes the computer execute the functions of all or some sections of the system according to the present invention described above.

Moreover, the present invention may be a medium which can be read on a computer, stores a program, makes a computer execute all or some functions of all or some sections of system according to the present invention described above, and allows the program to operate in co-operation with the computer and execute these functions.

The present invention also covers a recording medium which stores the program according to the present invention and which can be read on a computer.

In one example of use, the program according to the present invention may be recorded in a recording medium which can be read on a computer so that the program operates in co-operation with the computer.

In one example of use, the program according to the present invention may be transmitted through a transmission medium and read by a computer so that the program operates in co-operation with the computer.

The recording medium includes a ROM, etc., whereas the transmission medium includes a transmission medium such as the Internet, light, an electric wave, a sound wave, etc.

As described above, the computer referred to in the present invention is not limited pure hardware such as a CPU but may include firmware, OS, and further, peripheral equipment.

As described above, the structure according to the present invention may be realized by software or hardware.

### INDUSTRIAL UTILITY

The present invention is fair method to indicate search results and is useful in the internet search field.

### BRIEF DESCRIPTION OF THE DRAWINGS

FIG. 1 shows the construction of the search indication apparatus in the embodiment 1 of the present invention.

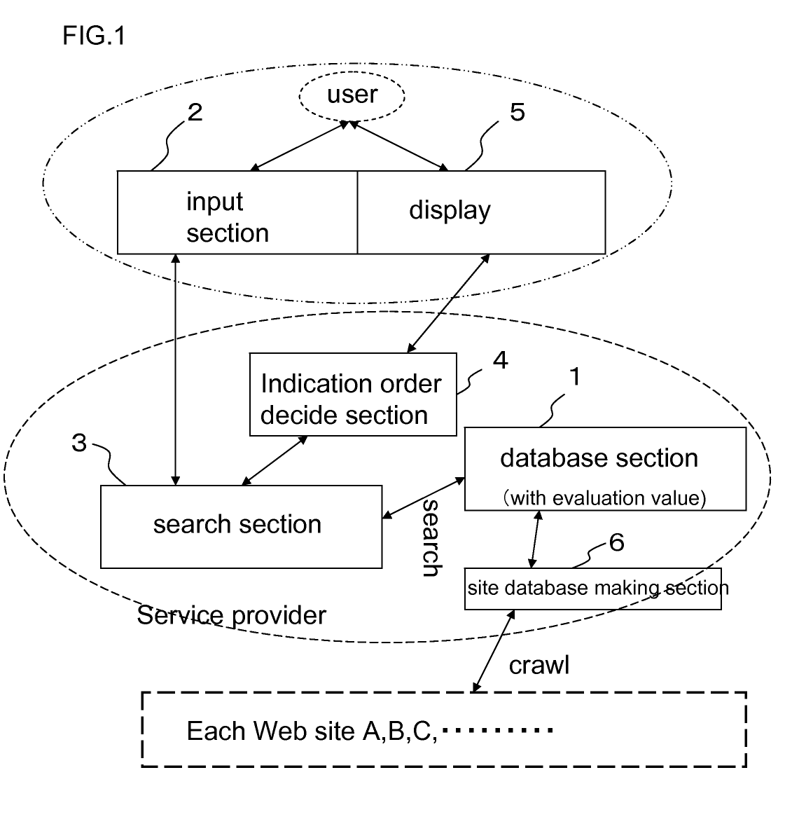

FIG. 2 shows a chart of operation of the apparatus of FIG. 1.

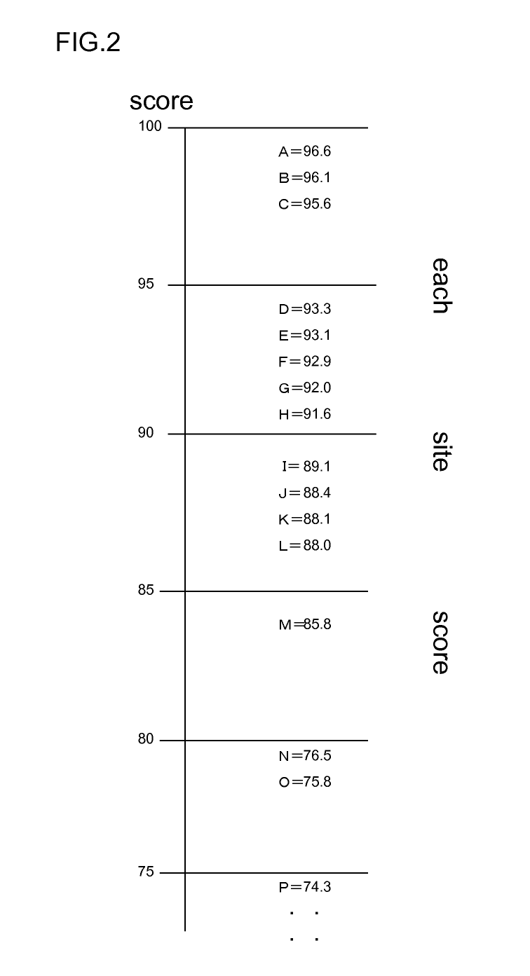

FIG. 3 shows a chart of operation of the apparatus of FIG. 1.

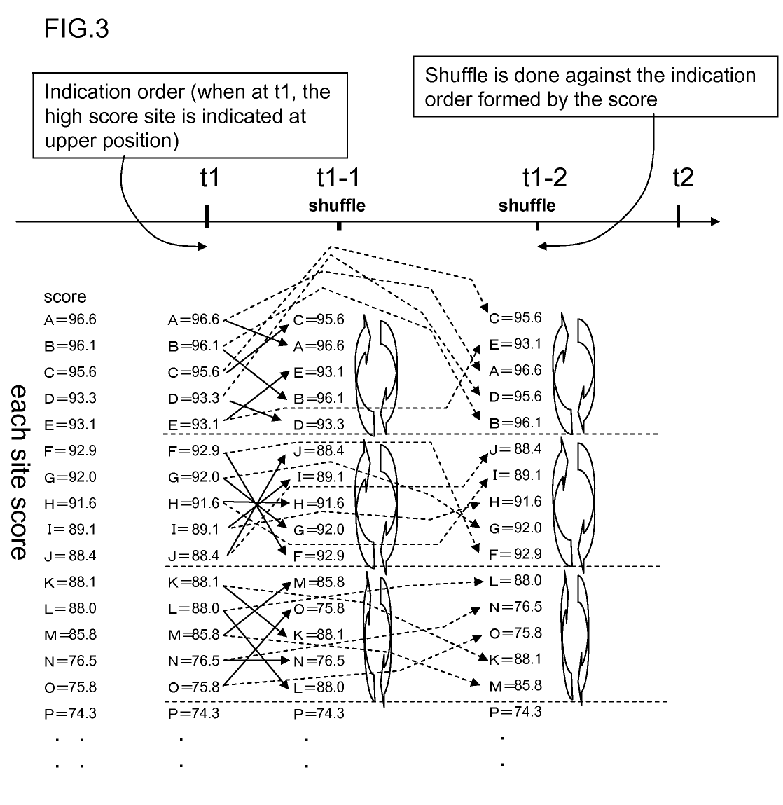

FIG. 4 shows a chart of operation of the apparatus of FIG. 1.

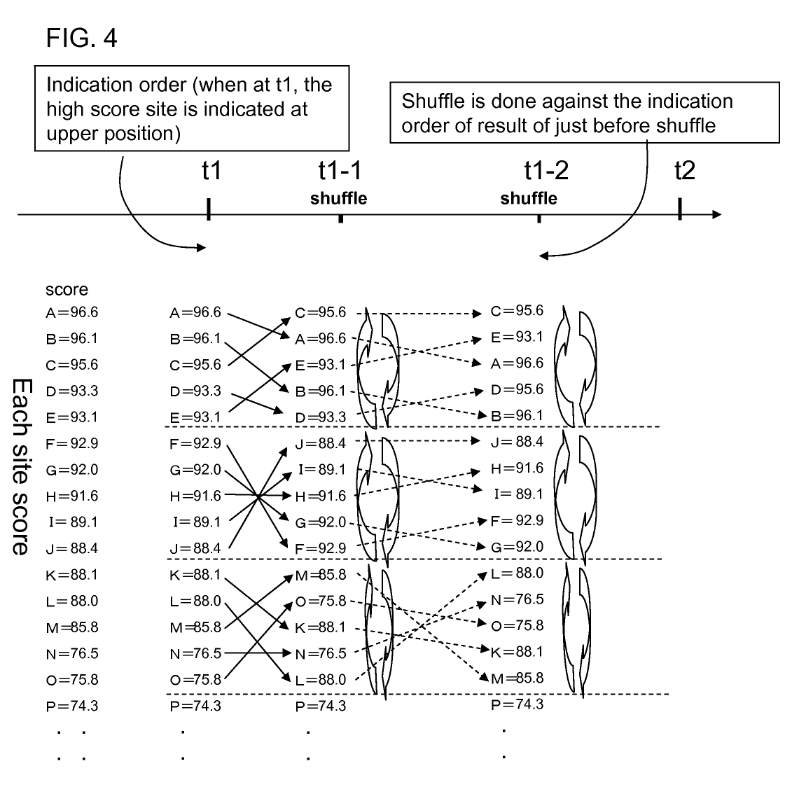

FIG. 5 shows a chart of operation of the apparatus of FIG. 1.

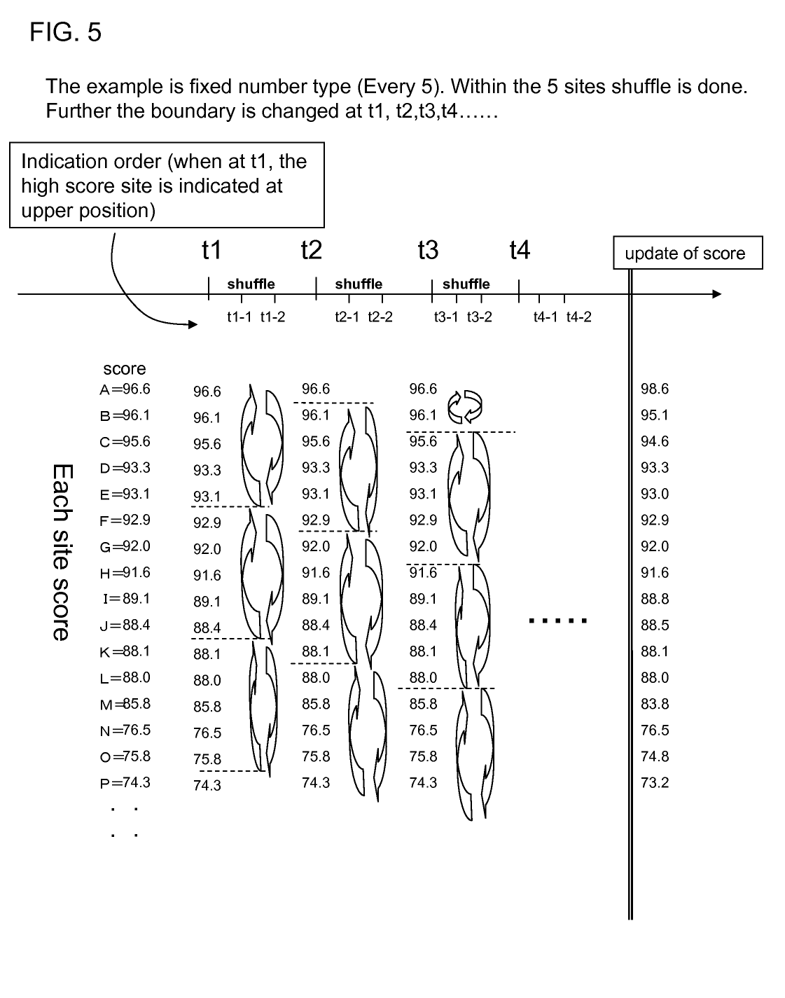

### DESCRIPTION OF SYMBOLS

1 database section

2 input section

3 search section

4 indication order decide section

5 display

6 database making section

What is claimed is:

1. A determining method of indication order of search results, wherein
when first indication order of site information for each searched and hit site is decided according to a predetermined rule, and second indication order of the site information for the each searched and hit site is decided on the basis of the first indication order of site information,
the second indication order is decided by shuffling indication order which is to be shuffled, at a predetermined timing and within a determined indication order range.

2. The determining method according to claim 1, wherein
scores which was finally added to the searched and hit sites, said scores being used for deciding the first indication order, are calculated by using evaluation value which is prepared beforehand for each site and distance between search keyword or key-sentence and contents of each site.

3. The determining method according to claim 1, wherein
the indication order which is to be shuffled, is the first indication order.

4. The determining method according to claim 1, wherein
the indication order which is to be shuffled, is such indication order which is result of the last time shuffle or which is result of the former shuffle.

5. The determining method according to claim 1, wherein
the predetermined indication order range is decided by number of sites.

6. The determining method according to claim 5, wherein
the number of sites is counted from high rank or low rank.

7. The determining method according to claim 5, wherein
the number is fixed or variable according to a certain rule.

8. The determining method according to claim 1, wherein
the predetermined indication order range is ratio for total number of the searched and hit sites.

9. The determining method according to claim 8, wherein
the ratio is counted from high rank or low rank.

10. The determining method according to claim 8, wherein
the ratio is fixed or variable according to a certain rule.

11. The determining method according to claim 1, wherein
the predetermined indication order range is decided by utilizing the scores which was finally added to the searched and hit sites, said scores being used for deciding the first indication order.

12. The determining method according to claim 2, wherein
the predetermined indication order range is decided by utilizing the value of the score.

13. The determining method according to claim 11, wherein
the predetermined indication order range is such certain indication order range where difference of the score values of the sites belonging to such range falls within a predetermined size.

14. The determining method according to claim 13, wherein
the predetermined size is counted from high rank or low rank.

15. The determining method according to claim 13, wherein
the predetermined size is fixed to a predetermined value width or is variable according to a certain rule.

16. The determining method according to claim 13, wherein
the predetermined size is decided on the basis of calculated score values.

17. The determining method according to claim 11, wherein
the predetermined indication order range is decided by a predetermined value width of the score.

18. The determining method according to claim 1, wherein
the predetermined indication order range is all searched and hit sites or a part of the all searched and hit sites.

19. The determining method according to claim 18, wherein
the part is a certain sites of high rank.

20. The determining method according to claim 1, wherein
the predetermined timing is at per user's search request, at a certain period, at random or at shuffle request of user.

21. The determining method according to claim 1, wherein
old the second indication order is recorded and later the old second indication can be indicated.

22. The determining method according to claim 1, wherein
boundary of adjacent predetermined indication order ranges is variable according to a predetermined rule.

23. A determining system of indication order of search results, comprising;
database section recording data of many sites,
search section searching for user's search request by using the database section, and
indication order decide section, where
in the indication order decide section,
when first indication order of site information for each searched and hit site is decided according to a predetermined rule, and second indication order of the site information for the each searched and hit site is decided on the basis of the first indication order of site information,
the second indication order is decided by shuffling indication order which is to be shuffled, at a predetermined timing and within a determined indication order range.

24. A program on the recording medium, realizing by the computer, the determining method of indication order of search results, wherein
when first indication order of site information for each searched and hit site is decided according to a predetermined rule, and second indication order of the site information for the each searched and hit site is decided on the basis of the first indication order of site information,
the second indication order is decided by shuffling indication order which is to be shuffled, at a predetermined timing and within a determined indication order range.
